(19) United States
(12) Patent Application Publication
(10) Pub. No.: US 2014/0218601 A1
(43) Pub. Date: Aug. 7, 2014

(54) ENCLOSURE FOR AN OPTICAL DEVICE

(71) Applicant: HARNISCHFEGER TECHNOLOGIES, INC., Wilmington, DE (US)

(72) Inventors: Ryan A. Munoz, Milwaukee, WI (US); Brian K. Hargrave, JR., Mequon, WI (US); Matthew J. Reiland, Mequon, WI (US); Wesley P. Taylor, Glendale, WI (US); Paul Sisneros, Milwaukee, WI (US)

(73) Assignee: HARNISCHFEGER TECHNOLOGIES, INC., Wilmington, DE (US)

(21) Appl. No.: 13/759,554

(22) Filed: Feb. 5, 2013

(51) Int. Cl. H04N 5/225

(52) U.S. Cl. CPC H04N 5/2251
USPC 348/373

(57) ABSTRACT

An enclosure for an optical device generally includes a housing defining an opening, a transparent element coupled to the opening, a cover coupled to the housing for movement relative thereto between an opened position and a closed position, an actuator operable to move the cover relative to the transparent element between the opened position and the closed position, and a power supply electrically coupled to the actuator. The actuator maintains the opened position when it receives power from the power supply, and returns the cover to the closed position in response to a loss of power.

### BACKGROUND

Optical devices (e.g., cameras) or sensors on industrial, construction or mining equipment are frequently exposed to environmental elements such as dust, dirt, rain, or snow. Through continued exposure to such environmental elements, the performance of the optical sensors may become impaired or inhibited and potentially damaged.

### SUMMARY

In one embodiment, the invention provides an enclosure for an optical device mounted on such equipment that generally includes a housing defining an opening, a transparent element coupled to the opening, a cover coupled to the housing for movement relative thereto between an opened position and a closed position, an actuator operable to move the cover relative to the transparent element between the opened position and the closed position, and a power supply electrically coupled to the actuator. The actuator maintains the opened position when it receives power from the power supply, and returns the cover to the closed position in response to a loss of power.

In another embodiment, the invention provides an optical device system that generally includes a housing defining an interior space and an opening, an optical device disposed in the interior space, a cover coupled to the housing for movement relative thereto between an opened position and a closed position, an actuator operable to move the cover between the opened position and the closed position, and a power supply electrically coupled to the actuator. The actuator maintains the opened position when it receives power from the power supply, and returns the cover to the closed position in response to a loss of power.

Other aspects of the invention will become apparent by consideration of the detailed description and accompanying drawings.

### BRIEF DESCRIPTION OF THE DRAWINGS

FIG. 1 is a top perspective view of an enclosure for an optical device, illustrating a cover in an opened position.

FIG. 2 is a top perspective view similar to FIG. 1, illustrating the cover in a closed position.

FIG. 3 is a bottom perspective view of the enclosure of FIG. 2.

FIG. 4 is a section view of the enclosure taken along line 4-4 of FIG. 2.

FIG. 5 is a section view of the enclosure taken along line 5-5 of FIG. 2.

FIG. 6 is a side view of the enclosure of FIG. 1, illustrating the cover in the opened position.

FIG. 7 is a side view similar to FIG. 6, illustrating the cover in the closed position.

FIG. 8 is a plan view of the enclosure of FIG. 1, illustrating the cover in the opened position.

FIG. 9 is a plan view similar to FIG. 8, illustrating the cover in the closed position.

FIG. 10 is a perspective view of an enclosure for an optical device according to another embodiment of the invention, including a housing and an a projection extending therefrom.

FIG. 11 is a side view of the enclosure of FIG. 10.

FIG. 12 is a plan view of the enclosure of FIG. 10.

FIG. 13 is a section view of the enclosure taken along line 13-13 of FIG. 12.

FIG. 14 is a side view of the enclosure of FIG. 10 with the housing and projection removed.

FIG. 15 is a plan view similar to FIG. 12 with the projection removed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

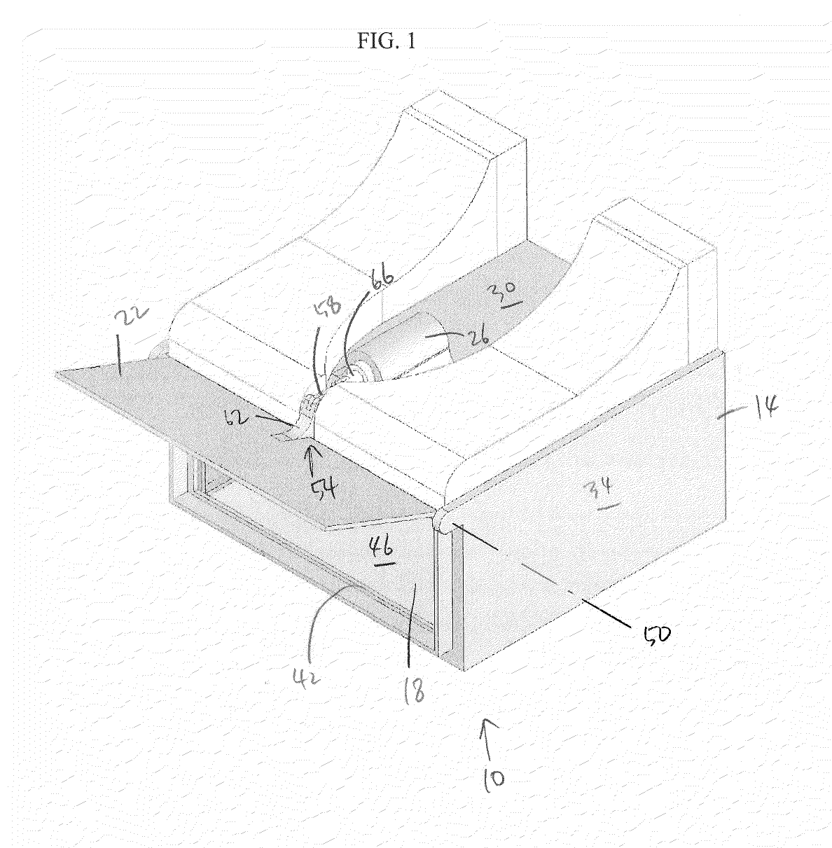

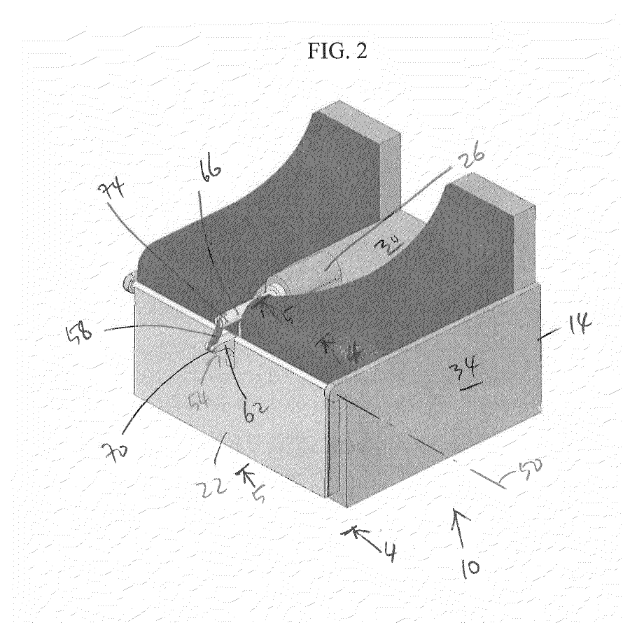

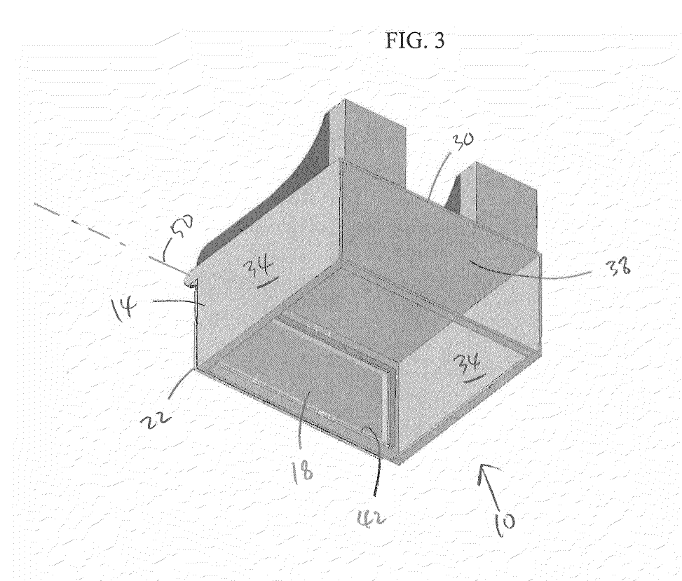

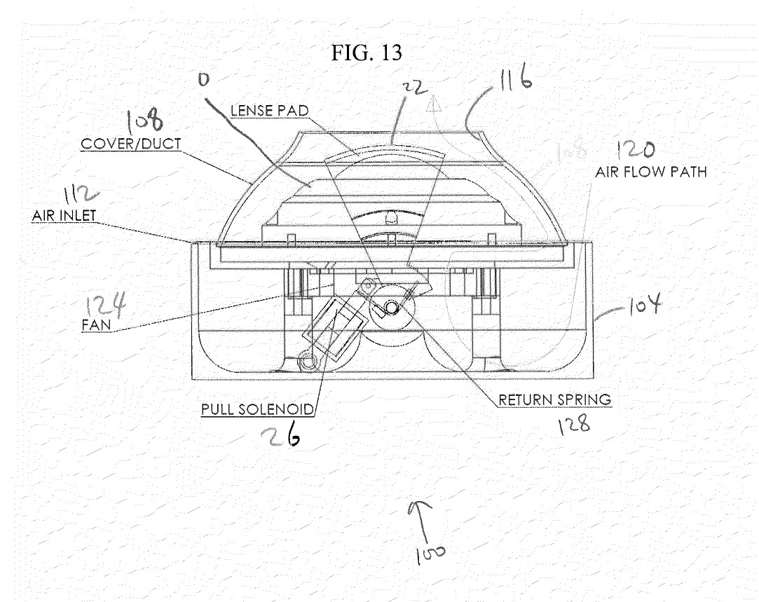

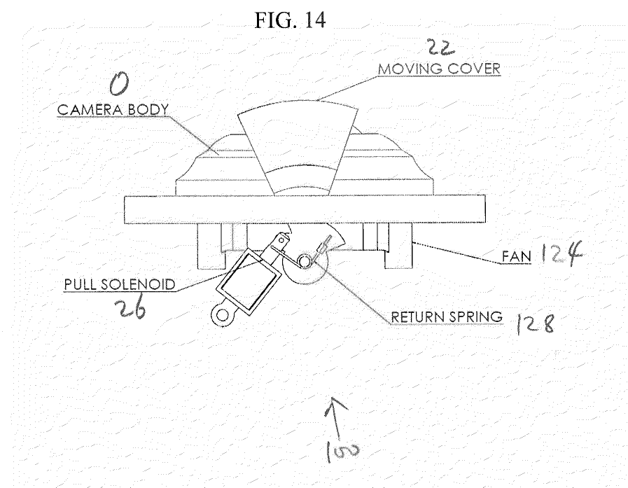

FIGS. 1 and 2 illustrate an enclosure 10 for an optical device O (not shown in FIGS. 1 and 2; see, e.g., FIGS. 13 and 14), including a housing 14, a transparent element 18, a cover or flap 22, an actuator 26, and a power supply (not shown). The optical device O may be a camera (for example for visible light or infrared), any device suitable for Light Detection And Ranging (LiDAR) technology and applications, and other optical sensors. The apparatus and articles of manufacture described herein are not limited in this regard. The housing 14 includes a top side 30 and side walls 34 extending therefrom. As used herein, the terms “top,” “bottom,” “front,” “rear,” “side,” and other directional terms are not intended to require any particular orientation, but are instead used for purposes of description only. Referring also to FIG. 3, the housing 14 defines an interior space 38 and an opening 42. An optical device (e.g., a camera or lens) or sensor may be disposed in the interior space 38, with the opening 42 positioned in front of the optical device O. The enclosure 10 and the optical device disposed therein may be positioned on a support structure (not shown). Although FIG. 3 illustrates a base and rear side of the housing 14 as left open, in other embodiments the housing 14 may include a base surface and rear side to fully enclose or contain the optical device O.

The transparent element 18 is coupled to the opening 42. In some embodiments, the transparent element 18 is formed from glass. In other embodiments, the transparent element 18 may be formed from any substantially transparent or translucent material so that an outside space is visible to the optical device O (e.g., for taking photographs). In the illustrated embodiment, the transparent element 18 defines an outer surface 46. The outer surface 46 inhibits environmental elements such as dust, dirt, rain, or snow from coating or abrasively contacting the optical device, while leaving the outside space visible to the optical device. In the illustrated embodiment, the transparent element 18 defines a substantially planar face and a lateral axis 50. In other embodiments, however, the transparent element 18 may assume any geometric form suitable to protect the optical device, for example from environmental elements.

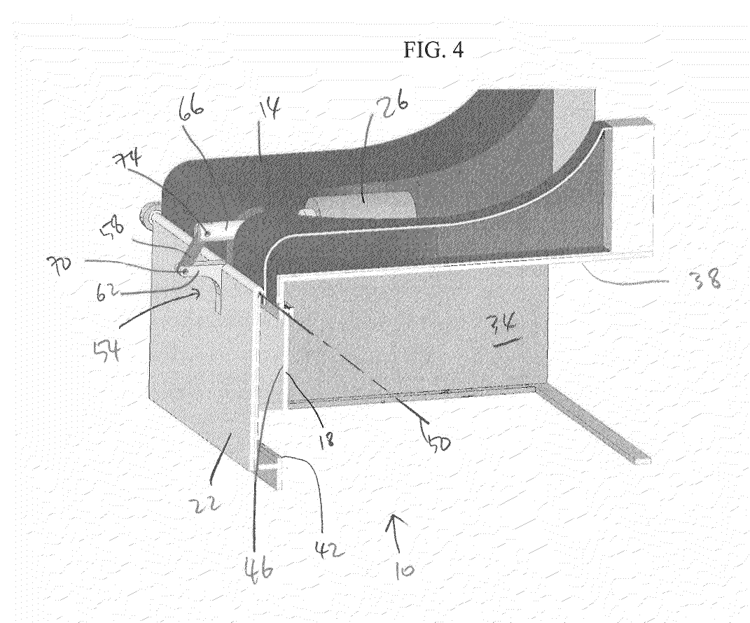

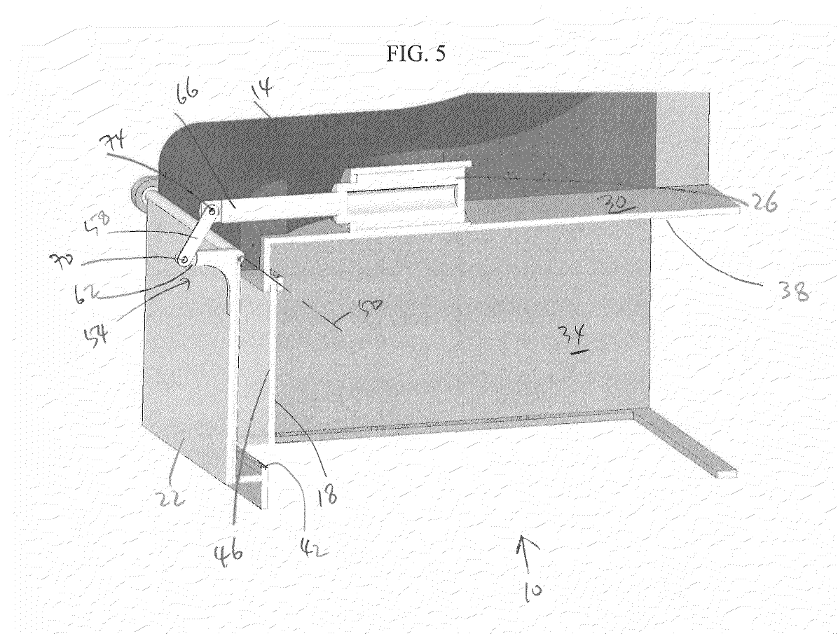

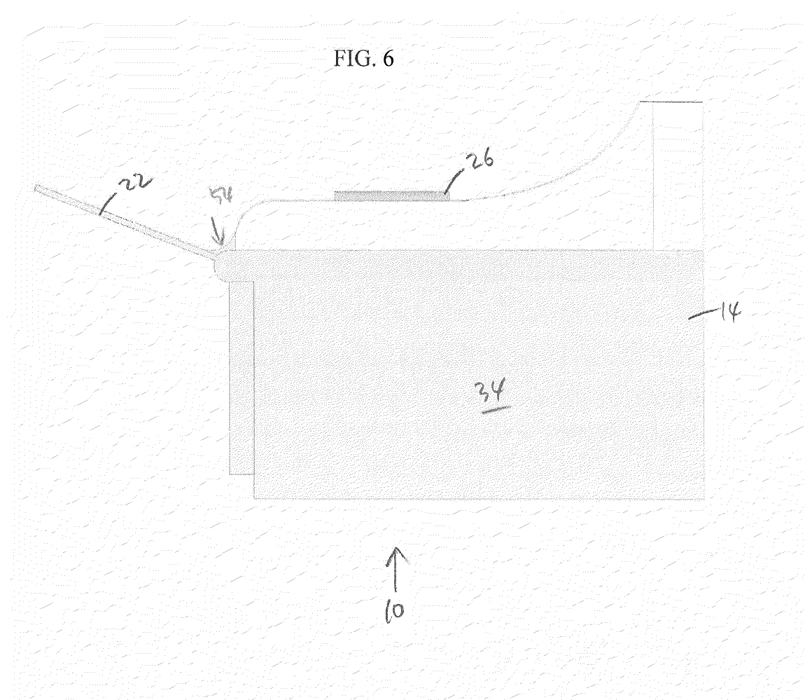

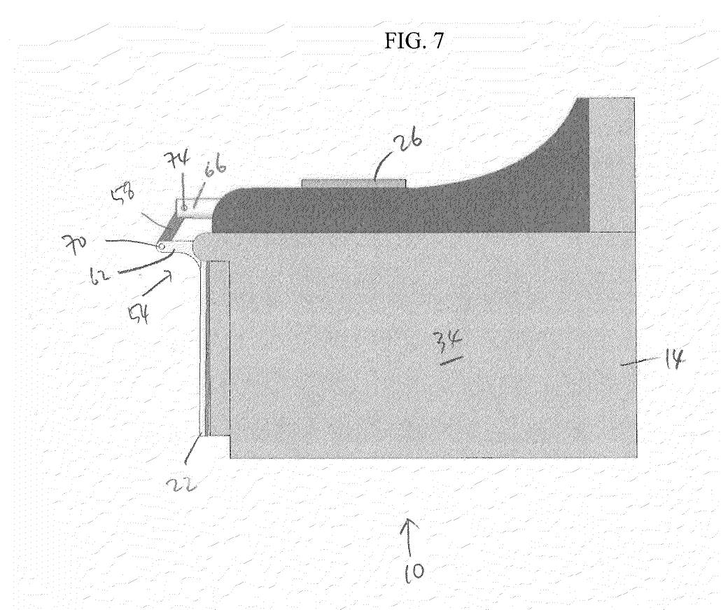

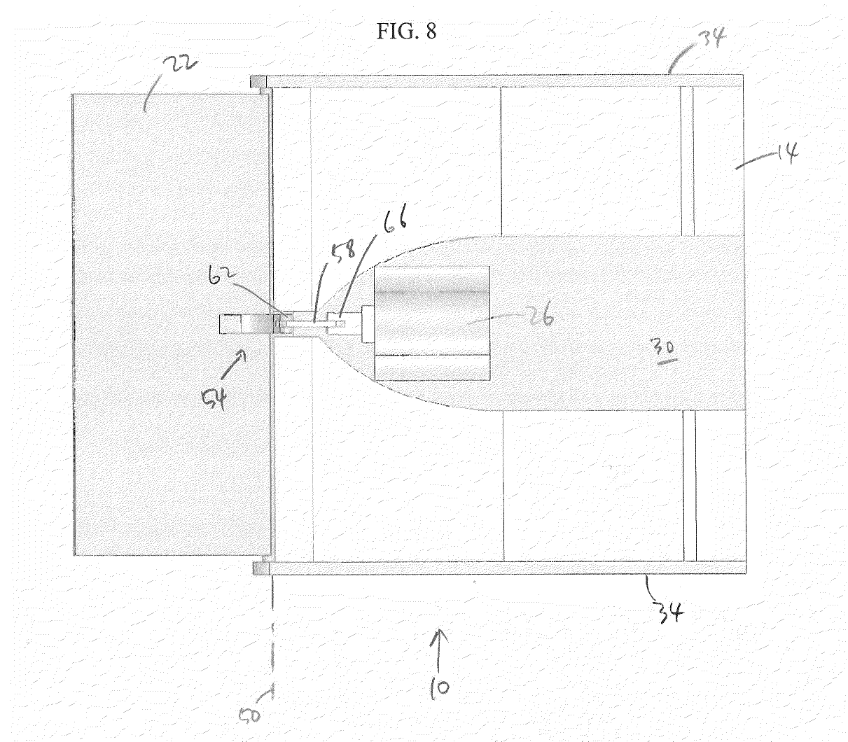

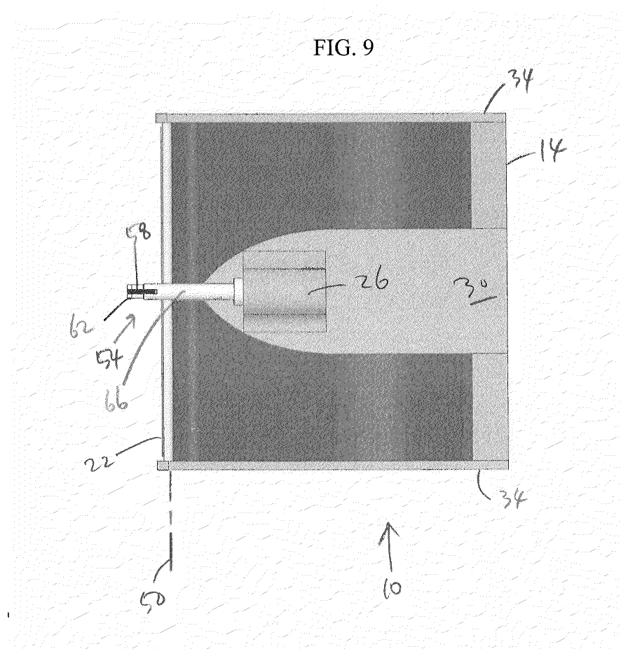

The cover 22 is coupled to the housing 14 for movement relative thereto between an opened position (see FIGS. 1, 6, and 8) and a closed position (see FIGS. 2-5, 7, and 9). In the illustrated embodiment, the cover 22 is substantially planar. In other embodiments, however, the cover 22 may assume any geometric form suitable to protect the transparent element 18 and/or the optical device. In the illustrated embodiment, the cover 22 is coupled to the housing 14 at a pivot joint 54. As such, the cover 22 is rotatable around the lateral axis 50 at the pivot joint 54. Although the illustrated pivot joint 54 is positioned adjacent the top side 30 of the housing 14, in other embodiments, the pivot joint 54 may be positioned at any other location suitable for rotatably moving the cover 22 relative to the housing 14. In some embodiments, the cover 22 seals the transparent element 18 in the closed position (e.g., along the edges or at corners of the cover 22 and transparent element 18). In other embodiments, however, the cover 22 may be moved adjacent the transparent element 18 without sealing it. In the illustrated embodiment, the cover 22 and the substantially planar face of the transparent element 18 are of substantially congruent shapes to fully cover the transparent element 18. In other embodiments, however, the cover 22 and the transparent element 18 may be of non-congruent shapes to partially cover the transparent element 18.

In the illustrated embodiments, the pivot joint 54 includes a coupling member 58 extendable between the cover 22 and housing 14. In particular, the illustrated pivot joint 54 includes female members 62, 66 coupled to the cover 22 and housing 14, respectively, the coupling member 58 extending between the female members 62, 66, and pins 70, 74 insertable through the female members 62, 66 and the coupling members 58 to couple the female members 62, 66 and the coupling member 58 together. Although the illustrated female members 62, 66 are separately formed and attached to a respective one of the cover 22 and housing 14, respectively (e.g., via fasteners or glue), in other embodiments the one or more female or male members may be integrally formed with the cover 22 and housing 14.

The actuator 26 is operable to move the cover 22 relative to the transparent element 18 between the opened position and the closed position. In some embodiments, the actuator 26 includes a solenoid. The solenoid may be energized when the encased optical device is receiving power, and de-energized when the optical device is not received power. In other embodiments, however, the actuator 26 may include any other mechanisms to suitably move the cover 22 relative to the transparent element 18 between the opened and closed positions.

The power supply is electrically coupled to the actuator 26. The actuator 26 maintains the opened position when it receives power from the power supply, and returns the cover 22 to the closed position in response to a loss of power. As such, the enclosure 10 automatically provides protection to the optical device until the power returns. The actuator 26 may accomplish moving the cover 22 relative to the transparent element 18 by means of mechanical, hydraulic, pneumatic, or electric systems depending upon the capabilities and configuration of the actuator 26. In some embodiments, the cover 22 may be closed under its own weight (e.g., by gravity) when the enclosure 10 loses power.

In some embodiments, the enclosure 10 further comprises at least one fan (not shown; see, e.g., FIGS. 13 and 14) operable to direct air across the outer surface 46 of the transparent element 18 when the cover 22 is in the opened position. The fan is capable of generating a positive air pressure to keep the optical device O clean or clear from dust and dirt in operation. In some embodiments, the fan ix positioned at the top side 30 of the housing 14 and directs dust and dirt clouds downwardly and away from the optical device. In other embodiments, however, the fan may be positioned at any other location suitable to blow air across the transparent element 18 and/or the optical device O. In some embodiments, when the fan loses power, the actuator 26 is de-energized and the cover 22 is closed to protect the transparent element 18 and/or the optical device O.

In some embodiments, the enclosure 10 further comprises an air inlet (not shown; see, e.g., FIG. 13) located adjacent the transparent element 18, and an air outlet (not shown; see, e.g., FIG. 13) disposed on the housing 14 substantially opposite the transparent element 18. An air passageway (not shown; see, e.g., FIG. 13) fluidly connects the air inlet with the air outlet. In some embodiments, the air inlet is positioned adjacent the top side 30 of the housing 14 and the air outlet is positioned adjacent a base of the housing 14 to facilitate the fan directing dust and dirt clouds downwardly and away from the optical device O. In other embodiments, however, the air inlet and outlet may be positioned at any other locations suitable to facilitate blowing air across the transparent element 18 and/or the optical device O.

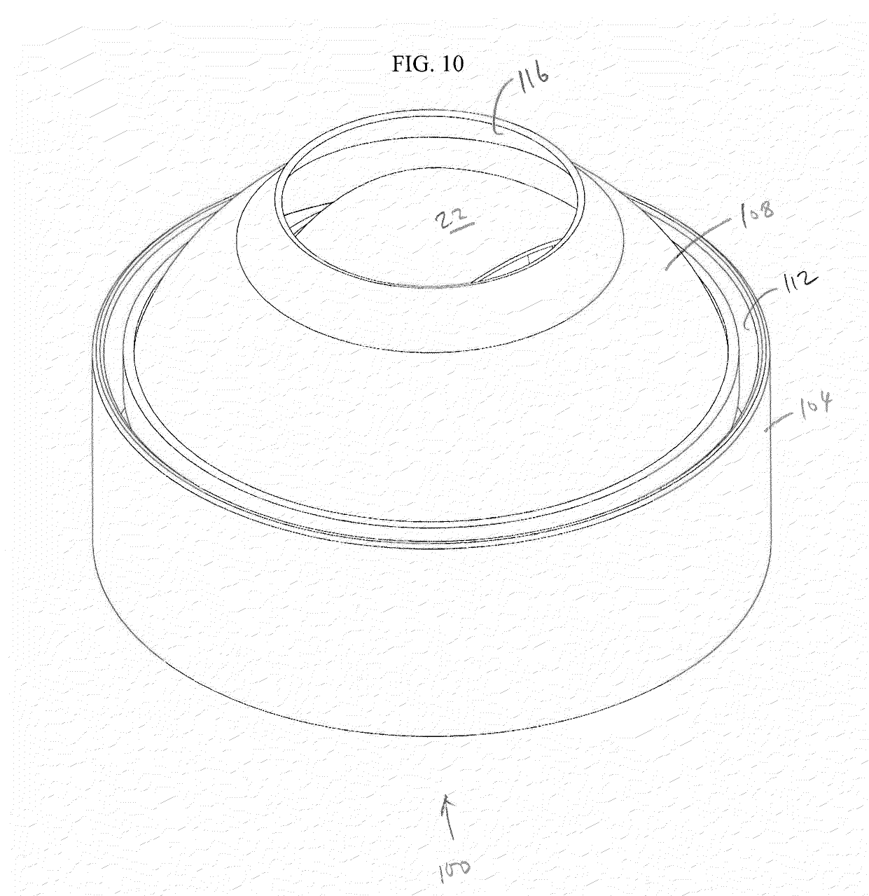

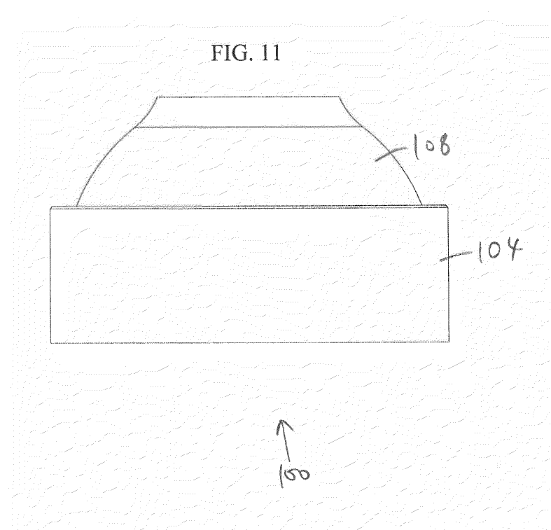

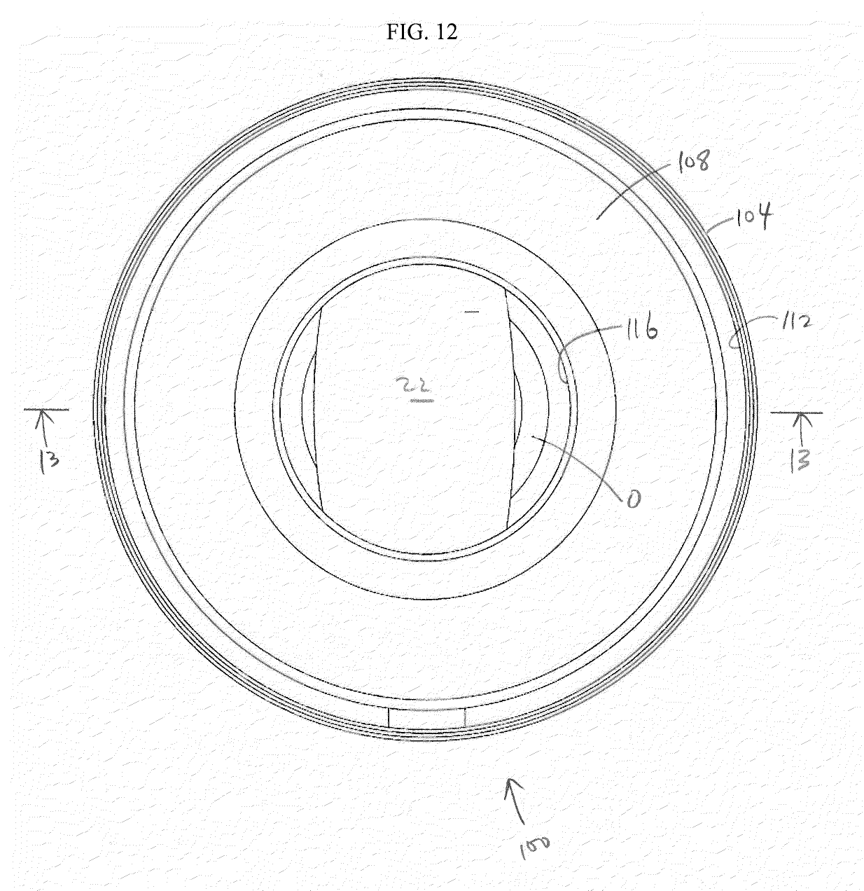

FIGS. 10-16 illustrate the enclosure 100 according to another embodiment of the invention. This embodiment employs much of the same structure and has many of the same features as the embodiment of the enclosure 10 described above in connection with FIGS. 1-9. Accordingly, the following description focuses primarily upon the structure and features that are different than the embodiment described above in connection with FIGS. 1-9. Reference should be made to the description above in connection with FIGS. 1-9 for additional information regarding the structure and features and possible alternatives to the structure and features of the enclosure 100 illustrated in FIGS. 10-16 and described below. Structure and features of the embodiments shown in FIGS. 10-16 that correspond to structure and features of the embodiment of FIGS. 1-9 are designated hereinafter with like reference numbers.

Referring to FIGS. 10-12, the housing 104 in this embodiment defines a projection or duct 108 extending away from the optical device O when the optical device O is positioned within the housing 104. An air inlet 112 is located adjacent a side periphery of the housing 104. The projection 108 defines an air outlet 116 disposed away from the air inlet 112. Also referring to FIG. 13, an air passageway 120 fluidly connects the air inlet 112 with the air outlet 116. Although FIG. 13 illustrates the air inlet 112 as positioned adjacent a side periphery of the housing 104 and the air outlet 116 as positioned at a distal end of the projection 108, in other embodiments, the air inlet 108 and outlet 112 may be positioned at any other locations suitable to facilitate blowing air away from the optical device O.

With continuing reference to FIG. 13, a fan 124 is operable to direct air away from the optical device O when the cover 22 is in the opened position. The fan 124 is capable of generating a positive air pressure to keep the optical device O clean or clear from dust and dirt in operation. In the illustrated embodiment, the fan 124 is positioned approximately at a center of the housing 14 and directs dust and dirt clouds upwardly and away from the optical device O. In other embodiments, however, the fan 124 may be positioned at any other location suitable to blow air away from the optical device O. In some embodiments, when the fan 124 loses power, the actuator 26 is de-energized and the cover 22 is closed to protect the transparent element 18 and/or the optical device O.

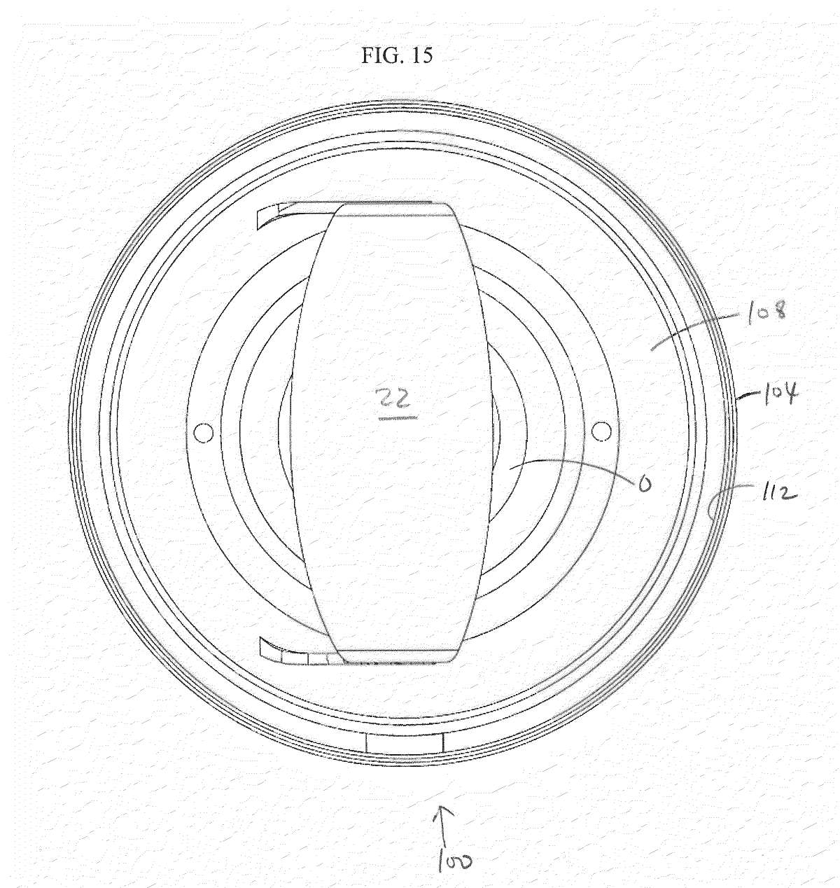

Referring also to FIGS. 14 and 15, the actuator 26 in this embodiment is biased or loaded by a spring 128 to resiliently return the cover 22 to the closed position when the enclosure 100 loses power. When the actuator 26 maintains the cover 22 in the opened position (e.g., to the left in FIGS. 14 and 15), the spring 128 is unwound to a predetermined distance. In absence of power, however, the spring 128 returns to its wound position and thereby draws the cover 22 more or less to the closed position (to the right in FIGS. 14 and 15). In other embodiments, the cover 22 may be loaded or biased by any other suitable mechanisms.

Although the invention has been described in detail with reference to certain preferred embodiments, variations and modifications exist within the scope and spirit of one or more independent aspects of the invention as described.

1. An enclosure for an optical device, comprising:
a housing defining an opening;
a transparent element coupled to the opening;
a cover coupled to the housing for movement relative thereto between an opened position and a closed position;
an actuator operable to move the cover relative to the transparent element between the opened position and the closed position; and
a power supply electrically coupled to the actuator, wherein the actuator maintains the opened position when it receives power from the power supply, and returns the cover to the closed position in response to a loss of power.

2. An enclosure as set forth in claim 1 further comprising at least one fan operable to direct air across the outer surface.

3. An enclosure as set forth in claim 2, wherein the actuator returns the cover to the closed position when the fan loses power.

4. An enclosure as set forth in claim 1 further comprising an air inlet located adjacent the transparent element, an air outlet disposed on the housing substantially opposite the transparent element, and an air passageway fluidly connecting the air inlet with the air outlet.

5. An enclosure as set forth in claim 1, wherein the cover is coupled to the housing at a pivot joint.

6. An enclosure as set forth in claim 5, wherein the pivot joint includes a coupling member extendable between the cover and housing.

7. An enclosure as set forth in claim 5, wherein the housing defines a top side, and wherein the pivot joint is positioned adjacent the top side.

8. An enclosure as set forth in claim 1, wherein the transparent element defines a lateral axis and wherein the cover is rotatable around the lateral axis.

9. An enclosure as set forth in claim 1, wherein the transparent element defines a substantially planar face.

10. An enclosure as set forth in claim 9, wherein the cover and the substantially planar face are of substantially congruent shapes.

11. An enclosure as set forth in claim 1, wherein the cover seals the transparent element in the closed position.

12. An optical device system comprising:
a housing defining an interior space and an opening;
an optical device disposed in the interior space;
a cover coupled to the housing for movement relative thereto between an opened position and a closed position;
an actuator operable to move the cover between the opened position and the closed position; and
a power supply electrically coupled to the actuator, wherein the actuator maintains the opened position when it receives power from the power supply, and returns the cover to the closed position in response to a loss of power.

13. A system as set forth in claim 12 wherein the housing defines a projection extending away from the optical device.

14. A system as set forth in claim 13 wherein the cover is positioned within the projection.

15. A system as set forth in claim 12 further comprising at least one fan operable to direct air away from the optical device.

16. A system as set forth in claim 12 further comprising an air inlet, an air outlet disposed on the housing away from the air inlet, and an air passageway fluidly connecting the air inlet with the air outlet.

17. A system as set forth in claim 12, wherein the cover is coupled to the housing at a pivot joint.

18. A system as set forth in claim 17, wherein the pivot joint is positioned within the housing.

19. A system as set forth in claim 12, wherein the housing defines a lateral axis and wherein the cover is rotatable around the lateral axis.

20. A system as set forth in claim 12, wherein the transparent element defines a substantially planar face.
